(19) United States
(12) Patent Application Publication
(10) Pub. No.: US 2005/0286685 A1
(43) Pub. Date: Dec. 29, 2005

(54) System and method for testing multiple dial-up points in a communications network

(76) Inventors: Nikola Vukovljak, London (GB); Nicholas Rutterford, London (GB)

Correspondence Address: BROWN, RAYSMAN, MILLSTEIN, FELDER & STEINER LLP, 900 THIRD AVENUE, NEW YORK, NY, 10022, US

(21) Appl. No.: 11/166,489

(22) Filed: Jun. 24, 2005

Related U.S. Application Data
(63) Continuation of application No. 09/928,245, filed on Aug. 10, 2001, now abandoned.

(51) Int. Cl. H04M 1/24; H04M 3/08

(52) U.S. Cl. 379/28; 379/29.01

(57) ABSTRACT

A monitoring station system and method for monitoring multiple dial-up points in a communications network, such as an Internet or intranet site. A single monitoring station runs dial monitor processes that can concurrently establish connections to, and test multiple dial-up points of, the site. Test data regarding availability and response time of the dial-up points can be obtained. Additionally, a transaction monitor process may run as a parent process of the dial monitor processes. The transaction monitor process provides service-specific monitors that use the established connections to the dial-up points to test services offered by, or via, the site, such as DHCP, HTTP and others. A different service of the site can be tested via each different connection. Specific testing is performed based on a profile that is tailored to customer needs. The connections may be established via analog modems, DSL modems, or ISDN terminal adapters/modems.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention relates to computer networks and, more specifically, to a system and method for testing dial-up points in a communications network such as a computer network from a monitoring station. In specific embodiments, the invention can be used to test dial up points of a computer site in a private network, such as an intranet, or a public network, such as the Internet. Furthermore, the invention may be used to test services that are offered by or through the computer site.

Corporate enterprises and other have become increasingly reliant on communications networks such as the Internet and other Internet Protocol (IP)-based networks for services, including information technology services. As a result, the availability, response time and other performance factors or metrics have become a critical area of concern. Thus, there is a need to test services offered by communication network sites to ensure they maintain performance standards, and to identify problem areas.

Various managing, test and monitoring approaches are known in communications networks. For example, U.S. Pat. No. 5,875,242 to Glaser et al., entitled “Telecommunications Installation And Management System And Method” discloses a device that is capable of managing and controlling a plurality of different types of telecommunications equipment. A single point of control for system management and data entry is provided.

U.S. Pat. No. 5,943,391 to Nordling, entitled “Method And Device For A Debugger And Test Data Collector” discloses a test unit that activates a modem to make a predetermined call through a telephone network to several remote data processing nodes. The test unit collects survey, snapshot and real-time data packets which are communicated to a BBS station for debugging the system and determining the performance of the system.

U.S. Pat. No. 5,974,237 to Shunner et al., entitled “Communications Network Monitoring” discloses a method of monitoring operational parameters of a communications network comprising a plurality of interconnected network elements, by contemporaneously performing a plurality of monitoring sessions, each monitoring a respective operational parameter or set of parameters of the network elements.

However, the prior approaches do not provide an efficient way to test multiple dial-up points in a communications network from a single monitoring station.

The present invention provides an advantageous system and method that addresses the above and other issues.

### SUMMARY OF THE INVENTION

The invention provides a system and method for testing multiple dial-up points in a communications network from a single monitoring station.

Generally, the invention provides a robust, scalable solution for the emerging area of enterprise management. The invention may provide realtime Internet availability and response time information on various Internet protocols and applications by regularly testing each service at user-defined intervals. Such service-level management information is invaluable to Internet service providers (ISPs), Web hosting organizations, and their customers, and others. As a result, the invention supports rapid rollout and effective use of emerging technologies including Voice Over IP, E-commerce, and the growing prevalence of Internet-based enterprises (e.g., intranets, including extranets). An extranet is considered to be a form of intranet that is partially accessible to authorized outsiders.

The invention allows testing of the availability of a particular dial-up point, such as the Point of Presence (POP) of an ISP or other communication network site. Or, when running in a transaction mode, as started by a transaction monitor process, the invention establishes a connection to a dial-up point to provide a route via which other steps of the transaction (e.g., other service specific transaction monitors started by the transaction monitor process) test their respective services.

A method in accordance with the invention includes the steps of executing instructions at a monitoring station for establishing a plurality of dial monitor processes, and establishing, via each process, a respective connection from the monitoring station to a respective dial-up point. Advantageously, the plurality of dial monitor processes (e.g., instances or threads) are adapted to run concurrently, at least in part, for establishing their respective connections.

The invention thus enables a single monitoring station to test multiple dial-up points quickly and efficiently.

The connection may be established using a variety of dial-up type techniques, such as those enabled using conventional analog modems, Digital Subscriber Line (DSL) modems, and Integrated Services Digital Network (ISDN) terminal adapters, also sometimes referred to as ISDN modems.

A corresponding apparatus and computer program product are also provided.

### BRIEF DESCRIPTION OF THE DRAWINGS

The invention is illustrated in the figures of the accompanying drawings which are meant to be exemplary and not limiting, in which like references are intended to refer to like or corresponding elements, and in which:

FIG. 1 illustrates a system for testing dial-up points in a computer network in accordance with the present invention;

FIG. 2 illustrates a service monitor event screen in accordance with the present invention;

FIG. 3 illustrates a flowchart of a standalone dial-up process for testing dial-up points in a communications network in accordance with the present invention; and

FIG. 4 (comprising FIGS. 4-1 and 4-2) illustrates a flowchart of a transaction monitor process for testing services of a network site, in accordance with the present invention.

### DETAILED DESCRIPTION OF THE PREFERRED EMBODIMENTS

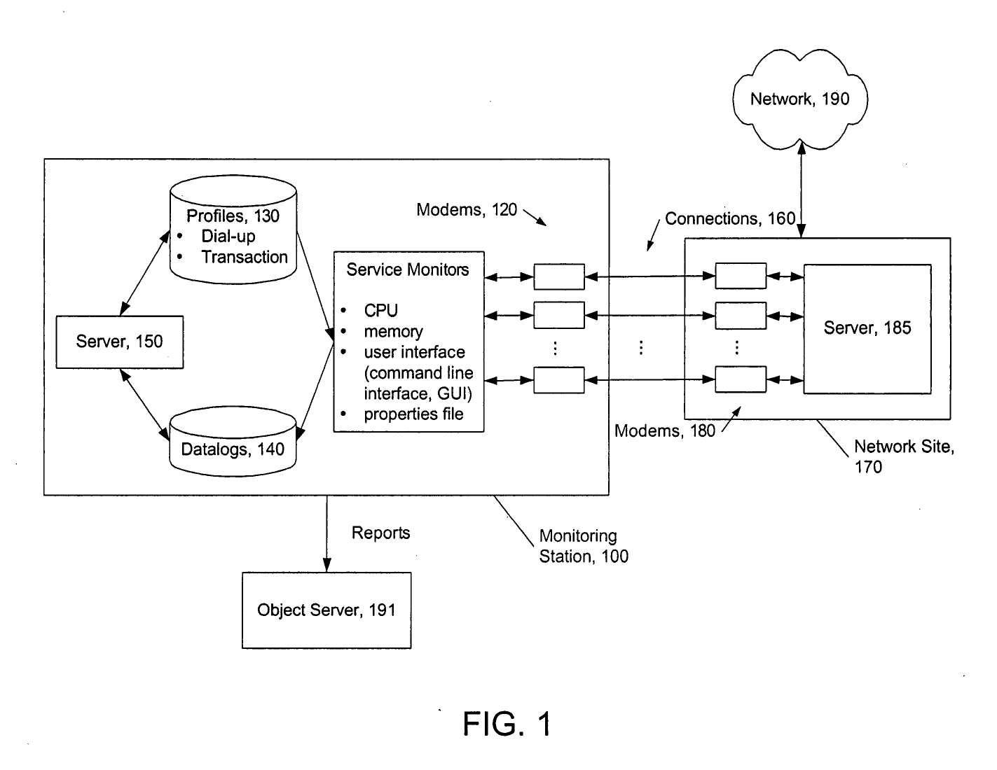

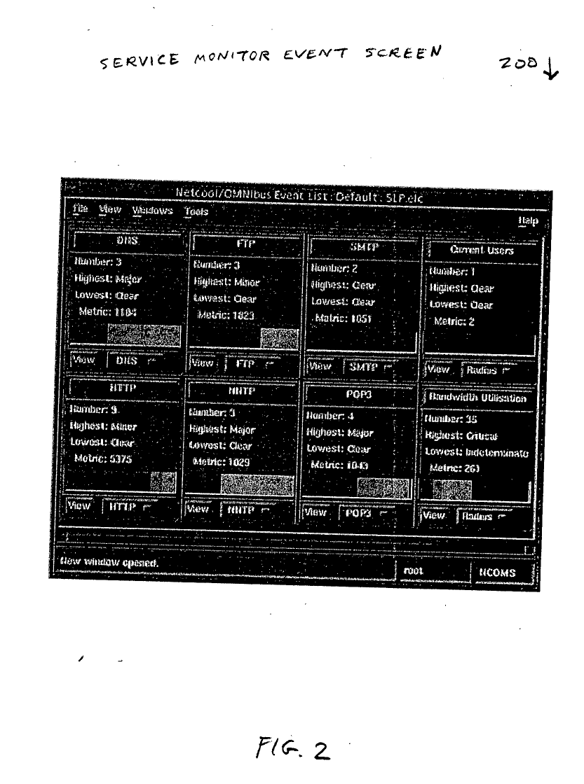

FIG. 1 illustrates a system for testing dial-up points in a communication network in accordance with the present invention. An example monitoring station 100 is provided to test an Internet/intranet site 170 or other communication network site or host. Advantageously, monitoring costs are reduced since a single monitoring station may test one or more sites. Multiple monitoring stations can also be deployed in concert. The site 170 may communicate via another example network 190 having other sites. In addition to testing the dial-up points, the monitoring station 100 may test services that are provided by, or via, the site 170. The monitoring station 100 may be located locally or remotely relative to the dial-up point.

The monitoring station 100 may report the test data it obtains to an object server 191. Such reports enable all SM servers to send out-of-bound and other reporting data in a user-specified format, e.g., to a Web or email location.

Various monitors analyze the test data and provide results to the operator, e.g., via an event screen or other graphical user interface (see also FIG. 2). A monitor may be provided for each of the services in the list further below. Further analysis or functionality, such as real-time fault management, and correlation with underlying network architecture, may also be provided.

The monitoring station 100 includes a Service Monitor (SM) 110, which may have a central processing unit (CPU), memory, user interface, such as a command line interface or GUI, and a properties file. The station 100 may be a workstation or other known computer device that operates using an operating system or platform, e.g., such as Solaris™/Linux or Microsoft Windows™ (NT/2000). Software instructions may be stored locally to the station 100 for executing by the CPU in a known manner. The SM 110 may receive profile information, discussed further below, from a profiles store 130, which in turn communicates with a SM server 150. The SM 110 stores test data results in a datalog 140, which also communicates with the server 150. In one possible embodiment, the SM Server 150 may be a 100% pure Java server to support the SMs by performing datalog management and profile management. In addition, the server 150 may distribute profiles to multiple monitoring locations, and the reporting data feeds obtained from the monitored locations to individual customer locations. The profiles 130 include a database of customer monitoring requirements, e.g., the parameters associated with the dial-up point or site that are of interest to the customer. The datalogs 140 include raw performance and service availability measurements recorded by the monitors.

The SM 10 may establish connections 160 via modems 120 of the monitoring station or local host 100 and modems or dial-up points 180 associated with the Internet/intranet site or remote host 170. The connections may be established using a variety of techniques, such as those enabled using conventional analog modems, DSL modems, and ISDN terminal adapters, also sometimes referred to as ISDN modems. Thus, the term “modem” may be used to denote a terminal adapter or the like. Conventional analog modems may use, e.g., the ITU V.90 standard or CCITT V.34 standard. The term DSL is meant to encompass DSL variations, sometimes referred to as xDSL. The SM 110 communicates with each modem via respective communication ports.

In an example implementation, the monitoring station 100 may use a single computer, with a bank of sixty-four modems that dial one or more network sites.

In additional to testing the availability, data rate and the like of the dial up points, the SM 110 may run a transaction monitoring process which acts like an end user of each service at the site 170 to measure the service's current status. The transaction monitor process can combine and manage a sequence of other monitors, e.g., to simulate the actions of a real user. Events are fed back into the locally managed datalogs 140, and optionally in real-time to an end user location.

The SM 100 may include a suite of proactive software monitors, each including specific executable rules, and property files. These monitors can constantly emulate a user of several different services, regularly ensuring that each service is available for access. Moreover, each monitor can be set to test the services at different time intervals. Response times, availability status and other information can be reported to the operators to allow them to maintain constantly updated views of their networks. The information obtained through monitoring the services may use the various monitors discussed further below, e.g., DHCP, HTTP, and so forth.

The invention may be implemented in conjunction with the Netcool® products available from Micromuse Inc., San Francisco, Calif. However, this is only one possibility, as the invention is also suitable for use with other network monitoring and testing products.

The invention delivers many tangible benefits, e.g., to any large organization hosting a Web site or conducting electronic commerce. Specifically, the invention can efficiently reduce labor costs associated with managing Web sites, and pinpoint areas for improving response time against stated service levels for e-mail, file transfer, Web page transmission and other services.

The invention enables Managed Network Service providers (MNSs), Internet Service Providers (ISPs) and others to manage critical Internet and other network services, such as those listed below. The corresponding Request For Comment (RFC) is noted where applicable.

DHCP Dynamic Host Configuration Protocol

DIAL a dial monitor for dial-up service via modem

DNS Domain Name Service (RFC 1035)

FTP File Transport Protocol (RFC 959)

HTTP HyperText Transfer Protocol (RFC 1945)

HTTP-S Secure Socket Layer HyperText Transfer Protocol

ICMP Internet Control Message Protocol

IMAP-4 Internet Message Access Protocol

LDAP Lightweight Directory Access Protocol

NNTP Network News Transfer Protocol (RFC 977)

NTP Network Time Protocol

POP3 Post Office Protocol (RFC 1939)

SNMP Simple Network Management Protocol

SMTP Simple Mail Transport Protocol (RFC 821)

RADIUS Remote Authentication Dial-In User Service (RFC 2139 & RFC 2138)

RPING Monitoring of Round Trip Times of pings between routers using Cisco Ping MIB

TCP PORT Port Transmission Control Protocol

The invention can assist management in commercial organizations in measuring and complying with customer-specific Service-Level Agreements (SLAs).

Thus, the Service Monitor (SM) 110, also referred to as an Internet Service Monitor (ISM) when used with the Internet, can actively monitor several critical Internet/intranet or other services offered by a site in a communication network. Data related to availability and response time is channeled into the object server 191, which is a central, high-performance, memory-resident repository that combines the speed of a high-performance relational database with the flexibility of an object-oriented framework.

Once service data is in the object server 191, operators can easily associate network response time and availability data with other enterprise-wide events and see the “big picture” to determine the cause of, and solutions to, any problems affecting their network sites.

In particular, the Service Monitors may track the higher level Internet and other communication network protocols and services, such as those listed above, by acting as a user of each service. Instead of passively waiting for a device or management system to, e.g., send out a Simple Network Management Protocol (SNMP) trap or log file message when something is wrong, the Service Monitors periodically test the sites, e.g., by attempting to access a URL or perform a file transfer (FTP). They then report information such as the time that it took to get a response, or whether the service is up and running at all.

Architecture of Service Monitors

The SMs may use a reliable message stream (e.g., TDS) for feeding data into the Object Server 191. Operators benefit from service-level views because they provide a true reflection of the current network status. Each of the supported protocols can be treated as a separate class with its own associated tools and resolutions.

The SMs may support the following features, among others:

1. SMs can be dynamically configured via the Web using a browser such as Netscape Navigator or Microsoft Explorer. Web-based configuration is based around the concept of “profiles,” as described below.

2. User-defined profile views. Profiles can correspond to a business unit, department, managed customer, or any set of monitor configurations, e.g., parameters of the dial-up point or site to be monitored. The concept of profiles may be extended to include a list of locations where the monitoring is to take place, and a list of places where historical time-based and SLA reports should be made available.

3. Extensible monitoring architecture. The ability to run monitors in multiple locations provides the means to present global use of services provided over the Internet or other network.

4. Centralized configuration of distributed monitors. Configuration is done centrally and distributed to all monitoring locations automatically via the “SM Server” that may run on the same machine as the SMs.

5. Threaded architecture. The SMs can monitor multiple servers and services of each protocol. For example, one HTTP monitor can track the availability and response time of both multiple Web servers and multiple pages within a given server.

6. Enhanced reporting. SMs support several types of reports including realtime, near realtime, and daily. (See “Reporting And Service-Level Management” section below.)

7. Time domain service correlation with enterprise-wide network events. All data collected by the SMs can be forwarded to the Object Server, filtered, and presented on a Graphical User Interface (GUI).

8. Built in Best Practice. The SMs may have built-in timeouts and thresholds for rapid deployment. These default values, which may be modified, e.g., using a Web configuration interface, offer a good starting point for expected level of service.

9. Proactive event support. In addition to thresholds, the SMs may proactively alert when service quality changes.

How SMs can be used by Internet Service Providers (ISPs) and Corporate Customers

1. ISPs:

An ISP managing multiple customers can accommodate the differing service levels for various customers with diverse requirements. Dynamic Web-based configuration allows for the automatic building of service views by adding information into lookup files, easing the maintenance associated with service-level management and Web-based reporting.

2. Corporations:

ISM's extensible monitoring architecture enables simulation of a typical dial-up, home-based Web transaction from a corporate Network Operations Center (NOC), even if, e.g., the NOC actually has a high-bandwidth T1 connection. The term “dial up” or the like as used herein is meant to encompass such connections, along with conventional Public Switched Telephone Network (PSTN) dial up connections. The use of multiple monitor locations within the network infrastructure enables partial service failures to be prioritized. This allows, for example, setting different priorities depending upon differing service-level agreements between the NOC and various internal departments.

Examples of Individual Functions of Service Monitors

HTTP Monitor. Monitors the availability and response time of HTTP Web servers. Can be configured down to individual page granularity. Can interact with a Common Gateway Interface bin interface to show availability of Web-based services, as well as check that specific content is found on a Web page (and alert if that content changes or is not present at all.) The HTTP monitor supports basic authentication, and also offers the ability to monitor applications with generic HTTP front ends.

HTTP-S Monitor. Monitors the availability and response time of Secure HTTP Web servers. Also supports all of the features of the HTTP monitor. In addition, the HTTPS monitor can talk Secure Sockets Layer (SSL) v2 and SSLv3 protocols, enabling direct communication with secure sites using strong (128-bit) encryption.

SMTP Monitor. Monitors the availability of the core backbone sendmail service by testing “sendmail” and similar agents. Typically works in conjunction with the POP3 and IMAP4 monitor to do end-to-end testing of the mail service by injecting mail messages.

POP3 Monitor. Monitors the front-end mail service. Connects to the POP3 service and acts as a client, authenticating against the server and examining text messages sent by the SMTP Monitor to calculate end-to-end mail delivery times.

IMAP4 Monitor. Monitors the front-end mail service. Connects to the IMAP4 service and acts as a client, authenticating against the server and examining text messages sent by the SMTP monitor to calculate end-to-end mail delivery times.

FTP Monitor. Monitors the software/file distribution service. Connects to the FTP service and downloads/uploads files to this service. Records response time and data transfer rates. Can also indicate whether or not there is free disk space, or if the file integrity has been maintained.

DNS Monitor. Monitors the Domain Name Service that underpins most ISP services. Provides both Forward and Reverse name lookups on multiple DNS servers for multiple lookup addresses and names. It parses the complete returned information, including MX records for mail services. It also checks the lookup response time for each request.

LDAP Monitor. Connects to any directory service supporting an LDAP interface and checks whether the directory service is available within response bounds and provides the correct lookup to a known entity.

RADIUS Monitor. Monitors the RADIUS. Performs a complete dial-in test against the service provider's RADIUS, checking the response time for user authentication for logon to a network site platform.

NNTP Monitor. Monitors the Internet News services. Checks to see if the service is available, and whether “new” news has been received on the monitored news groups. Both the local news process and the status of external data feeds can be reported upon.

PING/ICMP Monitor. Checks on the reachability of given IP addresses using the ICMP protocol. Can be used to measure network latency against given service-level requirements for different types of service.

Port Monitor. Allows a user-defined service, which runs on a known TCP port, to be monitored by the dynamic configuration of protocol chat scripts, which simulate a user of that service. Allows services such as a Telnet session to be quickly modeled into a global monitoring solution.

The SMs may be implemented as a suite of modular data collectors designed to run with Micromuse's flagship Netcool/OMNIbus system, available from Micromuse Inc., San Francisco, Calif., or with other appropriate products. Netcool/OMNibus is a client-server application based on the Object Server, which normalizes and synchronizes these events into a common format. This allows operators to custom design service views on-the-fly. Using Boolean filters, views are created based on which events affect the availability of user-oriented services. Probes, which are passive software modules, collect event data of hundreds of applications environments, management systems, and devices.

In Netcool's hierarchical model, a service is comprised of lower-level, more granular services. These services include key IP protocols, such as those tracked by the Service Monitors. Likewise, a service level is a linear set of hierarchical services. Events pushed into the Object Server by the Probes or Service Monitors define services in terms of binary status, e.g., “Good,” “Marginal,” “Unknown,” “Bad,” etc. These are correlated with the underlying network events such as “Link Down,” “Process Down,” “File System Above Threshold,” “Application Failure,” and so on.

In summary, the SMs can provide numerous benefits, including:
Provides the next generation of Internet/intranet or other communication network site service monitoring without requiring any changes to the existing operation center backbone architecture or management information structure;
Installs on, and generates reports on, all existing servers and management domains;
Leverages the service-level management infrastructure provided by Object Servers and Probes;
Supports customer profiling;
Supports the ability to monitor and measure the same resource from several points;
Allows managers and operators to visualize and respond to service availability trends as they occur;
Allows remote configuration of monitoring services with segregated customer profiles;

FIG. 2 illustrates a service monitor event screen in accordance with the present invention. The event screen 200 uses the test data, e.g., as stored at the datalogs and the SM server 150, to provide a report for the various services of the site 170 that are monitored by one or multiple SMs. Color-coded event summaries may be provided for each predefined service object. The summary may indicate the number of events, the severity of the events, and one or more numerical metrics associated with the related service.

The SM Server 150 may provide data for generating the screen or display 200 in the form of graphs against predefined service level metrics, and provide this information via a web interface. Historical data may be provided for each user profile, so that it is accessible through the SM server 150 using a web browser. Configuration of the service monitors may also be achieved via this web interface. Information may be entered on a per-profile basis, allowing for customization of data representation.

The monitors and the SM server 150 may exchange data via files in the Extensible Markup Language (XML) format, for example.

Monitors obtain profile information saved by the server 150, while the server can create graphs using datalog files 140, which contain data gathered by the monitors.

Reporting and Service-Level Management

The Service Monitors can collect response time and availability data at pre-defined, default intervals. The service monitor event screen 200 may display color-coded event summaries for each pre-defined service object.

1. Realtime reports. The monitors report realtime service availability and performance information to the Object Server.

2. Near realtime reports, distributed via the network. The “datalog” option of the SMs produces two types of near-realtime service-level reports, making them available over the Web or other network. These reports include simple “traffic light” type indicators and a visual data analysis tool allowing examination of trend data, e.g., using a Java applet.

3. Historical reports, typically run each night, are distributed to the network sites specified for each profile. Reports from monitors running in diverse locations can be brought together in a single location to present a global view of the performance of that service.

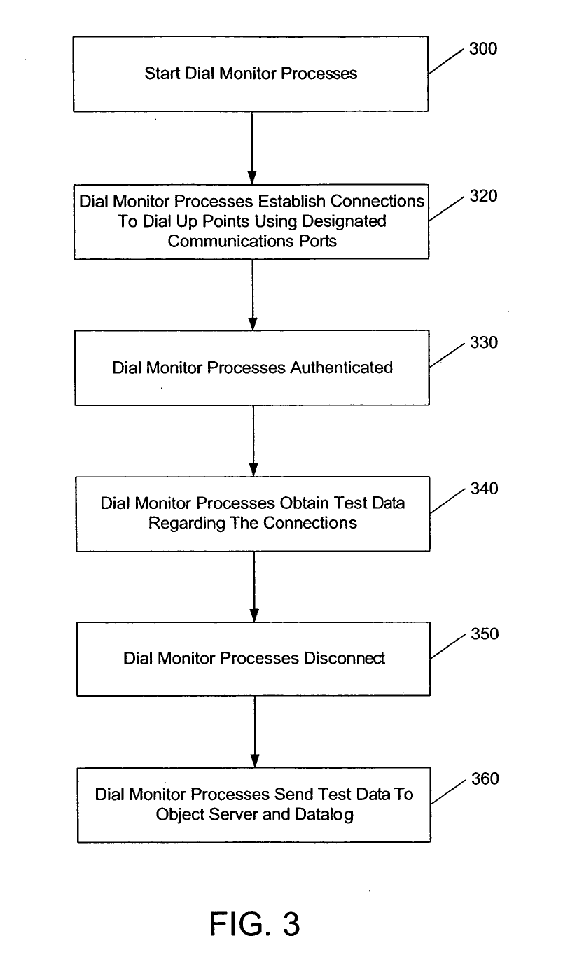

FIG. 3 illustrates a flowchart of a standalone dial-up process for testing dial-up points in a communication network in accordance with the present invention.

In a standalone mode, a number of dial monitor processes are started. The processes may be threads or instances, for example, depending on the platform used. Each dial monitor process parses a profile and opens a connection to a dial-up point. The specific procedure for establishing the connection will vary depending on the platform. A Solaris™/Linux™ implementation of the invention may spawn another process, such as a PPP daemon, which actually establishes a connection and a PPP link with the dial up point as a POP of the site. Such a daemon may also handle authentication with the dialed location. Alternatively, a Microsoft Windows™ (NT/2000) implementation of the invention may use a Microsoft Remote Access Service (RAS) Application Programming Interface (API) instead of a daemon, as this provides the developer with the interface to gather all the data the service monitor requires. Moreover, the use of this API allows for other changes to the monitor architecture detailed further below.

In the standalone mode, the Windows based monitor obtains configuration information based on profile entries. Once profiles are read, the Dial Monitor process spawns a thread for each “dial-up” connection. Each “dial-up” connection is defined by a “modemdevice” field in a profile entry. This also exists in a Solaris/Linux implementation, but a modemdevice command-line option or property entry is required to relate one to the other. The binary will be at any time running as many connection threads as there are different comms (communications) ports (as defined by “modemdevice” field entry) defined by profile entries.

A short period after the connection has been established, typically about one second (after authentication and establishing a successful connection), the dial monitor may disconnect from the dial-up point, and send data to the object server 191 and the datalog 140 regarding the connection, such as test data regarding availability, response time and other factors. This data may be provided via the dial monitor processes. For example, the dial monitor processes may provide timing data regarding the connection.

The behavior of each dial monitor process may be based on profile entries, and also controlled by “properties”, which can be entered either at command-line or read in from a properties file. Each monitor is capable of supporting multiple profiles. Note that the term “process” or the like is meant to encompass instances, such as used with Solaris/Linux platforms, as well as threads, such as used in Windows platforms. To enable multi-modem support, the dial monitor uses an additional property, “modemdevice”, which is also mirrored in an additional field in the dial monitor profiles. This is the case for the Solaris/Linux based implementation. For the Windows based implementation, the “modemdevice” property is not needed or used.

If a command line property, e.g., modemdevice, is related to an entry field in a profile, then if that property is invoked, only profiles that have corresponding entries will be run by that process of the monitor. So, any instance of the dial monitor will read profiles and only start a dial-up connection for the profile entry where the value of the “modemdevice” field matches the value of the “modemdevice” property that was used when starting this instance of the dial monitor. For example, the following code may be used to read all the profiles, finds an entry that has “modemdevice” field value “/dev/cua/b”, and open that connection through the designated communications port.
./nco_m dial_modemdevice/dev/cua/b->monitor

On Windows, the situation differs in that, as there is a single binary, profiles are read/parsed and a connection thread is created for each “modemdevice” profile entry. There is no need to try and synchronize multiple instances of the dial monitor with corresponding profile entries.

Each dial monitor process can establish a connection to one dial-up point at any one time. Moreover, multiple processes of the dial monitor can be run with different values for their “modemdevice” property to enable multiple dial monitor processes to establish respective different connections substantially at the same time. Each of these processes can test the profiles that have a corresponding value in their “modemdevice” field. For example, to test connectivity via three different ports, the following could be entered at the command line for a Sun Solaris™ platform implementation:
#./nco_m_dial-modemdevice/dev/cua/a-datalog &
#./nco_m_dial-modemdevice/dev/cua/b-datalog &
#./nco_m_dial-modemdevice/dev/cua/c-datalog &

Each of these processes may run (sequentially, if there is more than one) against a profile entry that has a corresponding value in its “modemdevice” field.

Or, depending on the platform that is used, a properties file could be used instead of the command line entries. For example, a command line interface may be used with a Unix platform, while a properties file may be used with a Windows platform.

It should be appreciated that various operating systems may be used, including, e.g., Sun Solaris™, Linux, Windows NT® and Windows 2000®. The code is used to command a communications port, and as understood by those skilled in the art, can vary based on the operating system, specific equipment used, and so forth.

In the above Solaris-specific syntax,/dev/cua/a, etc. are just port names, which will be different, e.g., on Linux. A Windows based implementation of the invention, in one possible implementation, does not need this, but may use a syntax as follows:
#./nco_m_dial-modemdevice<comms port 1>-datalog &
#./nco_m_dial-modemdevice<comms port 2>-datalog &
#./nco_m_dial-modemdevice<comms port 3>-datalog &
where < . . . > indicates changeable syntax.

The approach presented provides multi-modem support in the dial monitor standalone mode, and is part of the solution for the transaction mode.

The standalone process is summarized at blocks 300 through 360 in FIG. 3. The steps shown need not necessarily be performed in the order given. The multiple dial monitor processes are started (block 300) sequentially, concurrently, or in any other way. For example, for a Windows-platform based implementation, the processes may be threads that are started substantially in parallel. The dial monitor processes establish respective connections to dial up points of a network site using the designated communication port (block 320).

The dial monitor processes may be authenticated by the remote site (block 330). After the dial monitor processes obtain test data regarding their respective connections (block 340), they disconnect (block 350), and send their test data to the object sever and datalog (block 360). The test data may include data derived from the PPP daemon, when used.

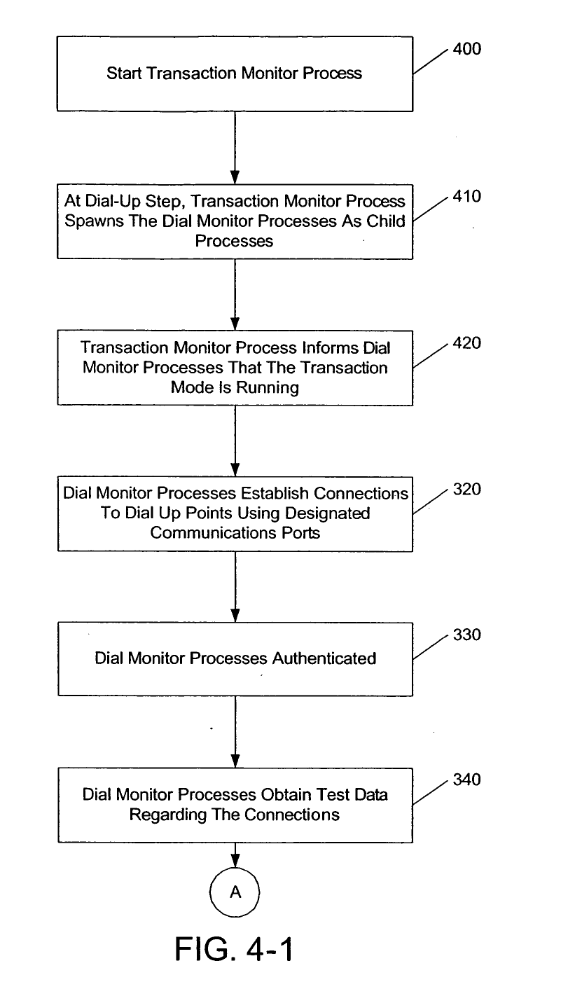

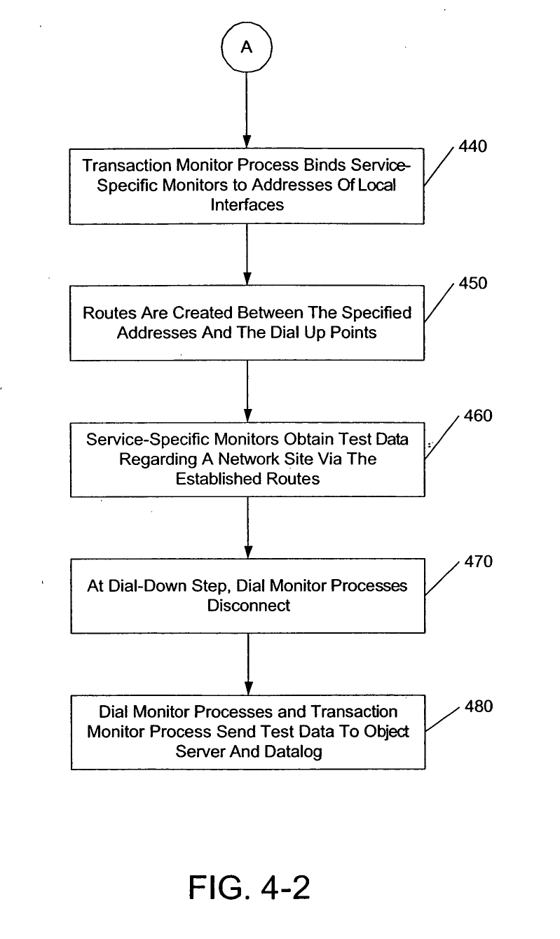

FIG. 4 (comprising FIGS. 4-1 and 4-2) illustrates a flowchart of a transaction monitor process for testing services of a network site, in accordance with the present invention.

In the transaction mode, the dial monitor processes are used in a transaction profile, and are started or spawned as child processes of a transaction monitor process. For example, the dial monitor processes may be started when a dial-up step in the transaction monitor process is reached. The dial-up step may be the first step in the transaction monitor process as these transactions generally aim to test services over a dial up link. As mentioned, the transaction monitor process can combine and manage a sequence of other monitors, e.g., to simulate the actions of a real user.

When the connection is established, other steps in the transaction can use the connection to test services of a site. The connection may be brought down when a dial-down step in the transaction monitor process is reached. The link may be brought down earlier if the transaction monitor process has failed at any step prior to the dial-down step. The network operator may define the conditions for failure. For example, for a transaction that is designed to connect with multiple sites, an inability to connect to a site may trigger a failure.

Moreover, for testing multiple transactions/services involving the connections, each connection will have its own discrete route over which the other steps in the transaction monitor process will test services. This ensures that data gathered via a connection is representative of that connection dial-up link.

After the transaction monitor process spawns the dial monitor processes as child processes in its dial-up step, it informs them that it is running in the transaction mode. This may be achieved, e.g., by passing command-line arguments to the dial monitor processes. The same applies to a Windows implementation as to a Solaris/Linux implementation, but with Windows, “modemdevice” property is not passed. Thus, the transaction monitor process is now modified to pass an additional command-line argument—“modemdevice”—with a value that corresponds to the “modemdevice” profile entry in the dial-up step.

At this point, testing of multiple concurrent transactions/services involving a dial-up connection is already possible. However, a problem may arise when the steps inside the transaction monitor process start testing services over the dial-up connection. When opening a connection to the remote host (e.g., network site), all other service-specific monitors in the transaction monitor processes allow the operating system to choose which local interface to connect from. This can lead to monitors that monitor the wrong dial-up link—not using the dial-up link that was opened for them, but another dial-up link that is also active at the time.

To solve this problem, the transaction monitor process can obtain an address such as the Internet Protocol (IP) address of the local host interface associated with a successful connection (dial monitor dial-up step). For example, this may be a PPP interface associated with a successful PPP link-up. The transaction monitor process also obtains the routing information associated with the connection and passes all this information to the service-specific monitors that are used in the further transaction steps. This allows the service-specific monitors to bind to the interface with the IP address that has been provided by the transaction monitor process, and create and use a route (using Operating System calls) between this IP address and the remote host being tested.

The transaction monitor has analogous functionality (as it appears to the user) as the Solaris/Linux version. One difference is that, when a dial process is spawned by the transaction monitor process, it will then spawn a connection thread (in Dial UP), or will signal the running dial monitor to shut down (on Dial Down). In a Solaris/Linux implementation, the dial monitor process spawns a PPP daemon process (on Dial UP) or signals the running PPP daemon process to shut down (on Dial Down).

The transaction monitor process is summarized in FIG. 4. Once the transaction monitor process is started (block 400), the dial monitor processes are spawned (block 410). At block 420, the dial monitor processes are informed that the transaction mode is running (block 420). This can be achieved in different ways depending on the platform.

Blocks 320-340 were discussed previously. Again, the order shown is an example only and does not necessarily denote discrete steps.

At block 440, the transaction monitor process binds the service-specific monitors to addresses of local interfaces. As discussed, this may be accomplished by having the transaction monitor process provide the IP addresses of a local interface that is associated with a successful connection to the service-specific monitors in further transaction steps. At block 450, a route/connection is created between the specified address and the dial up point or network site. At block 460, the service-specific monitors obtain test data regarding the network site via the established routes. For example, the HTTP monitor may test the availability of a web page, and an FTP monitor would test the transfer of files between hosts. At block 470, the dial monitor processes disconnect. At block 480, the acquired test data is sent to the object server and datalog.

Accordingly, it can be seen that the present invention provides a monitoring station system and method for monitoring a site on a communications network. A single monitoring station can concurrently test multiple dial-up points of the site using a dial monitor process that runs on the station. Significant reductions in complexity and cost can be realized since multiple test machines are not required to test services over multiple dial-up links concurrently. Test data regarding availability and response time of the connections to the dial-up points can be obtained. Additionally, a transaction monitor process may run as a parent process that uses the established connections to test services offered by, or through, the site. A different service can be tested via each different dial-up point. Specific testing is performed based on a profile that is tailored to customer needs. Test results are reported via an event screen. The connections may be established via analog modems, DSL modems, or ISDN terminal adapters/modems.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for testing multiple dial-up points in a communications network, comprising:
executing instructions at a monitoring station for establishing a plurality of dial monitor processes; and
establishing, via each process, a respective connection from the monitoring station to a respective one of the dial-up points;
wherein the plurality of dial monitor processes are adapted to run concurrently, at least in part, for establishing their respective connections.

2. The method of claim 1, wherein:
each process comprises a thread.

3. The method of claim 1, wherein:
each dial monitor process is provided as a distinct instance.

4. The method of claim 1, wherein:
the dial-up points are associated with an Internet site.

5. The method of claim 1, wherein:
the dial-up points are associated with an intranet site.

6. The method of claim 1, wherein:
each dial-up point comprises a point of presence in the network.

7. The method of claim 1, wherein:
the respective connections are established via respective analog modems.

8. The method of claim 1, wherein:
the respective connections are established via respective Digital Subscriber Line (DSL) modems.

9. The method of claim 1, wherein:
the respective connections are established via respective Integrated Services Digital Network (ISDN) terminal adapters.

10. The method of claim 1, further comprising:
executing instructions at the monitoring station for testing services of at least one site in the network via the dial-up points.

11. The method of claim 10, wherein:
wherein a different service of the at least one site is tested via each different dial-up point.

12. The method of claim 1, further comprising:
executing instructions at the monitoring station, via a transaction monitor process that spawns the dial monitor processes, for testing services of at least one site via the respective connections.

13. The method of claim 12, wherein:
the transaction monitor process tests the services according to an associated test profiles database.

14. The method of claim 1, wherein:
the respective connections are established using a application programming interface (API).

15. The method of claim 1, wherein:
the respective dial-up connections are established using a point-to-point protocol.

16. The method of claim 1, wherein:
the connections are established such that an interface local to the monitoring station is associated with each connection.

17. The method of claim 1, wherein service-specific monitors test services of at least one network site via the respective connections, further comprising:
obtaining addresses from the interfaces for use in binding the service-specific monitors to respective ones of the interfaces.

18. The method of claim 17, wherein;
said binding enables each service to be tested via a respective different connection.

19. The method of claim 17, wherein:
the addresses comprise Internet Protocol addresses.

20. The method of claim 1, further comprising:
executing instructions at the monitoring station, via each process, for testing the respective connections.

21. The method of claim 20, further comprising:
communicating test data obtained from the testing for storage at a remote server.

22. The method of claim 20, further comprising:
communicating test data obtained from the testing for storage at a local datalog.

23. The method of claim 20, wherein:
the connections are tested for availability.

24. The method of claim 20, wherein:
the connections are tested for data rate.

25. The method of claim 1, wherein:
the dial monitor processes run test profiles for testing the respective connections according to an associated test profiles database.

26. The method of claim 25, wherein:
the dial monitor processes run their test profiles in response to an invoked property if there is a correspondence between an associated property entry and the invoked property.

27. The method of claim 26, wherein:
the invoked property comprises a communication port identifier.

28. The method of claim 26, wherein:
the invoked property is entered by a user at a command line interface.

29. The method of claim 26, wherein:
the invoked property is read in from a properties file.

30. An apparatus for testing multiple dial-up points in a communications network, comprising:
means for executing instructions at a monitoring station for establishing a plurality of dial monitor processes; and
means for establishing, via each process, a respective connection from the monitoring station to a respective one of the dial-up points;
wherein the plurality of dial monitor processes are adapted to run concurrently, at least in part, for establishing their respective connections.

31. A computer program product, comprising:
a computer usable medium having computer readable program code means embodied therein for testing multiple dial-up points in a communications network from a monitoring station;
the computer readable program code means comprising means for executing instructions at the monitoring station for establishing a plurality of dial monitor processes, and means for establishing, via each process, a respective connection from the monitoring station to a respective one of the dial-up points;
wherein the plurality of dial monitor processes are adapted to run concurrently, at least in part, for establishing their respective connections.
